(19) United States
(12) Patent Application Publication
(10) Pub. No.: US 2026/0369014 A1
(43) Pub. Date: Nov. 19, 2026

(54) VIRTUAL REALITY SAFETY PROTECTION METHOD, ELECTRONIC DEVICE, AND NON-TRANSITORY MEDIUM

(71) Applicant: Beijing Zitiao Network Technology Co., Ltd., Beijing (CN)

(72) Inventor: Xiaolin RAO, Beijing (CN)

(21) Appl. No.: 19/142,500

(22) PCT Filed: Nov. 29, 2023
(86) PCT No.: PCT/CN2023/134877

§ 371 Date: Jun. 23, 2025

(30) Foreign Application Priority Data
Dec. 22, 2022 (CN) 202211656779.3

(51) Int. Cl. G06T 19/00; G06F 3/01; G06F 3/04815; G06F 3/16

(52) U.S. Cl. CPC G06T 19/006; G06F 3/011; G06F 3/04815; G06F 3/16

(57) ABSTRACT

Present disclosure is a virtual reality safety protection method, an electronic device and a non-transitory readable storage medium. The method includes: obtaining position information of a virtual reality display device and environment information of an environment where the virtual reality display device is located; determining a dynamic danger range in a static environment according to the environment information; and adjusting an interface transparent display parameter of the virtual reality display device and/or turning on a see-through mode, according to the position information and the dynamic danger range, to remind a user wearing the virtual reality display device.

The present application claims priority to Chinese Patent Application No. 202211656779.3, filed on Dec. 22, 2022, which is hereby incorporated by reference in its entirety as a part of the present application.

### TECHNICAL FIELD

Embodiments of the present disclosure relate to a virtual reality safety protection method and apparatus, an electronic device, a readable storage medium, a chip and a computer program product.

### BACKGROUND

At present, when a user uses a virtual reality (VR) device, the environment that the user sees is virtual, that is, the interface environment displayed in the VR is virtual, and the user's movement during the use process may collide with an obstacle in the real environment, which affects the personal safety of the user.

### SUMMARY

Embodiments of the present disclosure provide a virtual reality safety protection method and apparatus, an electronic device, a readable storage medium and a chip, which can solve the problem that the VR device is low in safety during the use process.

An embodiment of the present disclosure provides a virtual reality safety protection method, including: obtaining position information of a virtual reality display device and environment information of an environment where the virtual reality display device is located; determining a dynamic danger range in a static environment according to the environment information; and adjusting an interface transparent display parameter of the virtual reality display device and/or turning on a see-through mode according to the position information and the dynamic danger range, to remind a user wearing the virtual reality display device.

An embodiment of the present disclosure provides a virtual reality safety protection apparatus, including: an information obtaining module configured to obtain position information of a virtual reality display device and environment information of an environment where the virtual reality display device is located; a range determining module configured to determine a dynamic danger range in a static environment according to the environment information; and a prompt module configured to adjust an interface transparent display parameter of the virtual reality display device and/or turn on a see-through mode according to the position information and the dynamic danger range, to remind a user wearing the virtual reality display device.

An embodiment of the present disclosure provides an electronic device, including a processor, a memory, and programs or instructions stored in the memory and executable by the processor, where the programs or instructions, when executed by the processor, implement the steps of the method according to the first aspect.

An embodiment of the present disclosure provides a readable storage medium storing programs or instructions which, when executed by a processor, implement the steps of the method according to the first aspect.

An embodiment of the present disclosure provides a chip, including a processor and a communication interface, where the communication interface is coupled to the processor, and the processor is configured to run programs or instructions to implement the steps of the method according to the first aspect.

An embodiment of the present disclosure provides a computer program product, characterized in that the programs or instructions included in the computer program product, when running on a computer, cause the computer to implement the steps of the method according to the first aspect.

### BRIEF DESCRIPTION OF DRAWINGS

FIG. 1 is a flowchart of a virtual reality safety protection method according to an embodiment of the present disclosure;

FIG. 2 is a flowchart of a virtual reality safety protection method according to an embodiment of the present disclosure;

FIG. 3 is a flowchart of a virtual reality safety protection method according to an embodiment of the present disclosure;

FIG. 4 is a flowchart of a virtual reality safety protection method according to an embodiment of the present disclosure;

FIG. 5 is a structural diagram of a virtual reality safety protection apparatus according to an embodiment of the present disclosure;

FIG. 6 is a structural diagram of an electronic device according to an embodiment of the present disclosure; and

FIG. 7 is a structural diagram of an electronic device according to an embodiment of the present disclosure.

The correspondence between reference numerals and component names in FIG. 5 to FIG. 7 is as follows:

100: electronic device; 101: radio frequency unit; 102: network module; 103: audio output unit; 104: input unit; 1041: graphics processor; 1042: microphone; 105: sensor; 106: display unit; 1061: display panel; 107: user input unit; 1071: touch panel; 1072: other input device; 108: interface unit; 1109: memory; 1110: processor; 900: virtual reality safety protection apparatus; 901: information obtaining module; 902: range determining module; and 903: prompt module.

### DETAILED DESCRIPTION

The technical solutions in the embodiments of the present disclosure will be described clearly with reference to the drawings in the embodiments of the present disclosure. Apparently, the described embodiments are merely a part rather than all of the embodiments of the present disclosure. All other embodiments obtained by a person of ordinary skill in the art based on the embodiments in the present disclosure belong to the protection scope of the present disclosure.

The terms such as “first” and “second” in the specification and claims of the present disclosure are intended to distinguish between similar objects, but not to describe a particular order or sequence. It should be understood that the data described as such may be interchanged under appropriate circumstances, so that the embodiments of the present disclosure can be implemented in a sequence other than those illustrated or described herein. Moreover, the objects distinguished by “first” and “second” generally belongs to one type, and are not limited to a number of the objects, for example, the first object may be one or more. In addition, “and/or” in the specification and claims represents at least one of associated objects, and a character “/” generally represents an “or” relationship between associated objects.

The virtual reality safety protection method and apparatus, the electronic device, the readable storage medium and the chip according to the embodiments of the present disclosure will be described in detail below with reference to specific embodiments and application scenarios thereof with reference to FIG. 1 to FIG. 7.

The present embodiment provides a virtual reality safety protection method, as shown in FIG. 1, including:

Step S102: obtaining position information of a virtual reality display device and environment information of an environment where the virtual reality display device is located;

Step S104: determining a dynamic danger range in a static environment according to the environment information; and

Step S106: adjusting an interface transparent display parameter of the virtual reality display device and/or turning on a see-through mode of the virtual reality display device, according to the position information and the dynamic danger range, to remind a user wearing the virtual reality display device.

The virtual reality safety protection method according to this embodiment is mainly applied to the field of VR. When the user uses the virtual reality display device to view a virtual scene, the environment scene that the user sees is presented through the virtual reality display device, and the perception of the real actual environment is weak, so there may be a danger that the body collides with a real obstacle. In the present disclosure, the specific position of the virtual reality display device will be obtained first, and the surrounding environment of the device, that is, environment information, will also be obtained. By analyzing the environment information, it is possible to determine the range in the static environment that is prone to collision, that is, the dynamic danger range. For this range, the user generally will not touch it if he does not move significantly, for example, turning his head in place, waving hands, and other actions. However, if the user is immersed in the virtual world displayed by the virtual reality display device and will move forward, backward, left, and right, at this time, it is monitored in real time whether the current position of the device has invaded the dynamic danger range. If the current position of the device has invaded the dynamic danger range, the transparency of the interface displayed to the user is adjusted, that is, the interface transparent display parameter of the virtual reality display device is adjusted, or the default see-through mode is directly turned on, so that the external environment can be observed, and the possible collision position can be shown to the user in advance, thereby improving the use safety of the user.

It should be added that the dynamic danger range mentioned in this embodiment is comprehensive calculation and evaluation, which takes into account the collision-prone range in the static environment and a dynamic intruders, that is, not only the collision-prone range in the static environment can be determined through calculation of the static environment, but also the user can be reminded in the case where an outsider or an external object suddenly intrudes into the environment where the user uses the virtual reality display device due to an accident, thereby greatly improving the safety of the user when wearing the virtual reality display device.

It should be emphasized that the adjustment of the transparency of the interface in the present disclosure needs to be judged in real time according to the position information and the dynamic danger range, so that the safety of the user can be predicted in advance when the user is walking, and the safety of the user using the virtual reality display device can be improved while reducing interference with the user's operation as much as possible.

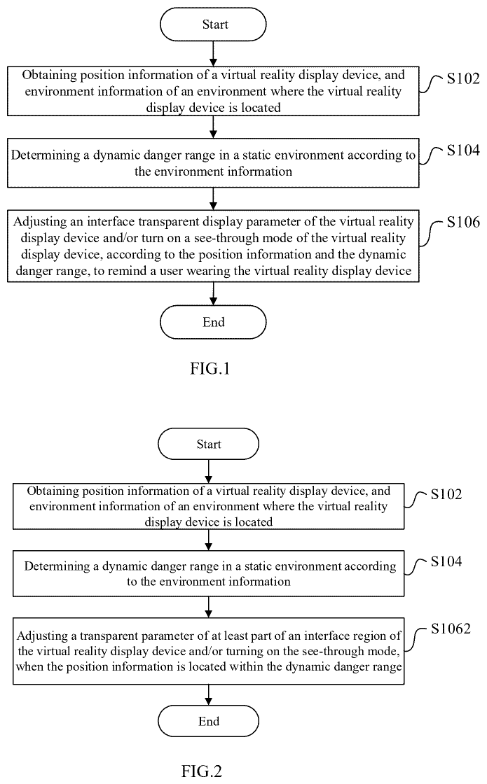

Optionally, as shown in FIG. 2, the adjusting the interface transparent display parameter of the virtual reality display device and/or turning on a see-through mode, according to the position information and the dynamic danger range, specifically includes:

Step S1062: adjusting a transparent parameter of at least part of an interface region of the virtual reality display device and/or turning on the see-through mode, when the position information is located within the dynamic danger range.

When adjusting the interface transparent display parameter, the position information and the dynamic danger range need to be determined. Through the division of the environment space described above, a safe range and the dynamic danger range are obtained. The user can move freely in the safe range, but when the user moves to the dynamic danger range while wearing the virtual reality display device, there is a safety hazard. In order to ensure the use safety of the user, at this time, the transparent of some or all of the interfaces in the virtual reality display device will be adjusted, that is, the transparent parameter of at least part of the interface region in the virtual reality display device will be adjusted, or the see-through mode will be turned on, and it is even possible to adjust the transparent parameter and turn on the see-through mode at the same time, so that the user can see the reality scene without removing the virtual reality display device, and the measure of predicting and avoiding possible injury is implemented, thereby greatly improving the safety of the user.

It can be understood that the transparent parameter is the transparency displayed in the interface region, and if the transparency is 0, the user can directly see the reality scene through the virtual reality display device.

Generally, it is determined through prediction that the user is about to collide. In order to ensure the experience of the user using the virtual reality display device, the transparency of only the corresponding interface region will be adjusted to half, so that the use safety of the user is improved without affecting the normal use of the device.

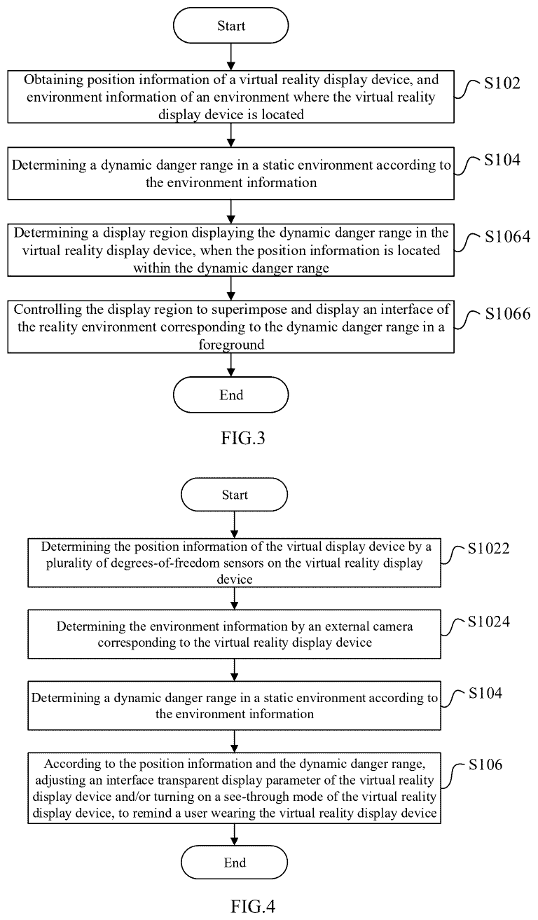

Optionally, as shown in FIG. 3, the adjusting the interface transparent display parameter of the virtual reality display device according to the position information and the dynamic danger range, specifically includes:

Step S1064: determining a display region displaying the dynamic danger range in the virtual reality display device when the position information is located within the dynamic danger range; and

Step S1066: controlling the display region to superimpose and display an interface of the reality environment corresponding to the dynamic danger range in a foreground.

In another embodiment, when adjusting the interface transparent display parameter, the position information and the dynamic danger range need to be determined. Through the division of the environment space described above, a safe range and the dynamic danger range are obtained. The user can move freely in the safe range, but when the user moves to the dynamic danger range while wearing the virtual reality display device, there is a safety hazard. In order to ensure the use safety of the user, at this time, the reality region displaying the dynamic danger range of the reality scene in the virtual reality display device is determined first, and at this time, the reality scene only needs to be superimposed and displayed on the display region in the foreground, so that the user can know the situation that needs to be predicted and avoided, and the use safety of the user can also be improved.

Optionally, as shown in FIG. 4, the obtaining the position information of the virtual reality display device and the environment information of the environment where the virtual reality display device is located, further includes: step S1022: determining the position information of the virtual display device by a plurality of degrees-of-freedom sensors on the virtual reality display device; and step S1024: determining the environment information by an external camera corresponding to the virtual reality display device.

The present disclosure mainly uses the degrees-of-freedom sensor provided by the virtual reality display device to determine the specific position information, where the position information includes a moving position and a full-angle turning position of the virtual reality display device, so as to facilitate the mixing of the virtual scene displayed by the virtual reality display device and the reality scene with a safety hazard. When wearing the virtual reality display device, it is advantageous to accurately and intuitively display the safety hazard area to the user.

Further, adjusting a vibration frequency of the virtual reality display device when the position information is located within the dynamic danger range; and/or controlling the virtual reality display device to play a reminder audio when the position information is located within the dynamic danger range; and/or controlling at least part of an interface of the virtual reality display device to display a video image corresponding to the dynamic danger range when the position information is located within the dynamic danger range.

When there is a safety hazard, the present disclosure not only adjusts the transparency of the display interface, but also plays a vibration, a loudspeaker, and a specific video according to the hardware carried by the specific virtual reality display device, and superimposing various methods can play a better reminder role for the user.

As shown in FIG. 5, an embodiment of the present disclosure provides a virtual reality safety protection apparatus 900. The virtual reality safety protection apparatus 900 includes an information obtaining module 901, a range determining module 902, and a prompt module 903.

The information obtaining module 901 is configured to obtain position information of a virtual reality display device and environment information of an environment where the virtual reality display device is located. The range determining module 902 is configured to determine a dynamic danger range in a static environment according to the environment information. The prompt module 903 is configured to adjust an interface transparent display parameter of the virtual reality display device and/or turn on a see-through mode according to the position information and the dynamic danger range, to remind a user wearing the virtual reality display device.

Optionally, the prompt module 903 is further configured to adjust a transparent parameter of at least part of an interface region of the virtual reality display device when the position information is located within the dynamic danger range.

Optionally, the prompt module 903 is further configured to determine a display region displaying the dynamic danger range in the virtual reality display device when the position information is located within the dynamic danger range; and control the display region to superimpose and display an interface of the reality environment corresponding to the dynamic danger range in a foreground.

Optionally, the information obtaining module 901 is further configured to determine the position information of the virtual display device by a plurality of degrees-of-freedom sensors on the virtual reality display device; and determine the environment information by an external camera corresponding to the virtual reality display device.

Optionally, the prompt module 903 is further configured to adjust a vibration frequency of the virtual reality display device when the position information is located within the dynamic danger range; and/or control the virtual reality display device to play a reminder audio when the position information is located within the dynamic danger range; and/or control at least part of an interface of the virtual reality display device to display a video image corresponding to the dynamic danger range when the position information is located within the dynamic danger range.

The virtual reality safety protection apparatus in the embodiments of the present disclosure may be an apparatus, or may be a component, an integrated circuit, or a chip in a terminal. The apparatus may be a mobile electronic device or a non-mobile electronic device. Exemplarily, the mobile electronic device may be a mobile phone, a tablet computer, a notebook computer, a palmtop computer, an in-vehicle electronic device, a wearable device, an ultra-mobile personal computer (UMPC), a netbook, a personal digital assistant (PDA), or the like, and the non-mobile electronic device may be a server, a network attached storage (NAS), a personal computer (PC), a television (TV), a teller machine, a self-service machine, or the like, which are not specifically limited in the embodiments of the present disclosure.

The virtual reality safety protection apparatus in the embodiments of the present disclosure may be an apparatus having an operating system. The operating system may be an Android operating system, an ios operating system, or other possible operating systems, which are not specifically limited in the embodiments of the present disclosure.

The virtual reality safety protection apparatus according to the embodiments of the present disclosure can implement various processes implemented by the method embodiments of FIG. 1 to FIG. 4, which will not be repeated here to avoid repetition.

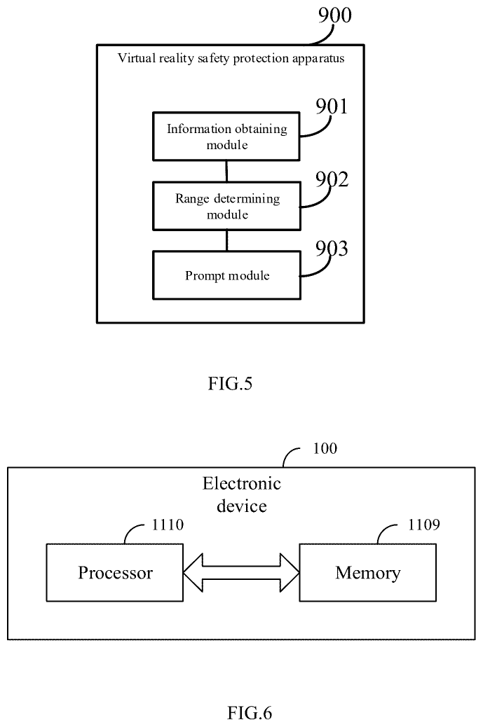

Optionally, as shown in FIG. 6, an embodiment of the present disclosure further provides an electronic device 100, including a processor 1110, a memory 1109, and programs or instructions stored in the memory 1109 and executable by the processor 1110. The programs or instructions, when executed by the processor 1110, implement the various processes of the above-mentioned embodiments of the virtual reality safety protection method, and can achieve the same technical effects, which will not be repeated here to avoid repetition.

It should be noted that the electronic device in the embodiments of the present disclosure includes the above-mentioned electronic device and non-electronic device.

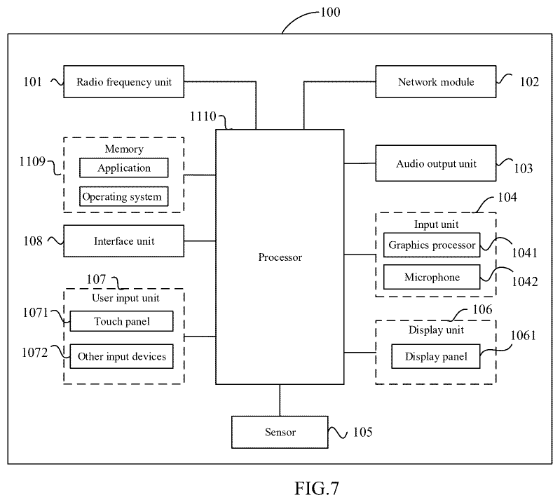

FIG. 7 is a schematic diagram of a hardware structure of an electronic device for implementing embodiments of the present disclosure.

The electronic device 100 includes, but is not limited to, components such as a radio frequency unit 101, a network module 102, an audio output unit 103, an input unit 104, a sensor 105, a display unit 106, a user input unit 107, an interface unit 108, a memory 1109, and a processor 1110.

It can be understood by those skilled in the art that the electronic device 100 may further include a power supply (such as a battery) for supplying power to each component, and the power supply can be logically connected to the processor 1110 through a power management system, so as to implement functions such as charging management, discharging management, and power consumption management through the power management system. The structure of the electronic device shown in FIG. 7 does not constitute a limitation of the electronic device, and the electronic device may include more or fewer components than those shown in the figure, or a combination of some components, or different component arrangements, which will not be repeated here.

The processor 1110 is configured to obtain position information of a virtual reality display device and environment information of an environment where the virtual reality display device is located; determine a dynamic danger range in a static environment according to the environment information; and adjust an interface transparent display parameter of the virtual reality display device and/or turn on a see-through mode, according to the position information and the dynamic danger range, to remind a user wearing the virtual reality display device.

Through the above solution, the specific position of the virtual reality display device is first obtained, and the surrounding environment of the device, that is, the environment information, is also obtained. By analyzing the environment information, a range in the static environment that is prone to collision, that is, the dynamic danger range, can be determined. For this range, the user generally will not touch it if he does not move significantly, for example, turning his head in place, waving hands, and other actions. However, if the user is immersed in the virtual world displayed by the virtual reality display device and will move forward, backward, left, and right, at this time, it is monitored in real time whether the current position of the device has invaded the dynamic danger range. If the current position of the device has invaded the dynamic danger range, the transparency of the interface displayed to the user is adjusted, that is, the interface transparent display parameter of the virtual reality display device is adjusted, and/or the see-through mode is turned on, so that the possible collision position can be shown to the user in advance, thereby improving the use safety of the user.

Optionally, the processor 1110 is further configured to implement the following step: adjusting a transparent parameter of at least part of an interface region of the virtual reality display device when the position information is located within the dynamic danger range.

Optionally, the processor 1110 is further configured to determine a display region displaying the dynamic danger range in the virtual reality display device when the position information is located within the dynamic danger range; and control the display region to superimpose and display an interface of the reality environment corresponding to the dynamic danger range in a foreground.

Optionally, the processor 1110 is further configured to determine the position information of the virtual display device by a plurality of degrees-of-freedom sensors on the virtual reality display device; and determine the environment information by an external camera corresponding to the virtual reality display device.

Optionally, the processor 1110 is further configured to adjust a vibration frequency of the virtual reality display device when the position information is located within the dynamic danger range; and/or control the virtual reality display device to play a reminder audio when the position information is located within the dynamic danger range; and/or control at least part of an interface of the virtual reality display device to display a video image corresponding to the dynamic danger range when the position information is located within the dynamic danger range.

It should be understood that in the embodiment of the present disclosure, the input unit 104 may include a graphics processor (Graphics Processing Unit, GPU) 1041 and a microphone 1042, and the graphics processor 1041 processes image data of a static picture or a video obtained by an image capturing apparatus (such as a camera) in a video capturing mode or an image capturing mode. The display unit 106 may include a display panel 1061, and the display panel 1061 may be configured in forms such as a liquid crystal display, an organic light emitting diode, and so on. The user input unit 107 includes a touch panel 1071 and other input devices 1072. The touch panel 1071 is also referred to as a touchscreen. The touch panel 1071 may include two parts: a touch detection apparatus and a touch controller. The other input devices 1072 may include, but are not limited to, a physical keyboard, function keys (such as a volume control key, a switch key, etc.), a trackball, a mouse, and a joystick, which will not be repeated here. The memory 1109 may be used to store software programs and various data, including but not limited to applications and operating systems. The processor 1110 may integrate an application processor and a modem processor, where the application processor mainly processes an operating system, a user interface, an application, etc., and the modem processor mainly processes wireless communication. It can be understood that the above-mentioned modem processor may not be integrated into the processor 1110.

An embodiment of the present disclosure further provides a readable storage medium storing programs or instructions which, when executed by a processor, implement the various processes of the above-mentioned embodiments of the virtual reality safety protection method, and can achieve the same technical effects, which will not be repeated here to avoid repetition.

The processor is the processor in the electronic device in the above-mentioned embodiment. The readable storage medium includes a computer-readable storage medium, such as a computer read-only memory (Read-Only Memory, ROM), a random access memory (Random Access Memory, RAM), a magnetic disk or an optical disk, etc.

An embodiment of the present disclosure further provides a chip, including a processor and a communication interface, where the communication interface is coupled to the processor, and the processor is configured to run programs or instructions to implement the various processes of the above-mentioned embodiments of the virtual reality safety protection method, and can achieve the same technical effects, which will not be repeated here to avoid repetition.

It should be understood that the chip mentioned in the embodiments of the present disclosure may also be referred to as a system-on-chip, a system chip, a chip system, or a system-on-chip, etc.

An embodiment of the present disclosure further provides a computer program product, where the programs or instructions included in the computer program product, when running on a computer, cause the computer to implement the steps of the virtual reality safety protection method in the method embodiments.

It should be noted that, in this text, the terms “include”, “comprise”, or any other variation thereof are intended to cover non-exclusive inclusion, so that a process, method, article, or apparatus including a series of elements not only includes those elements, but also includes other elements not explicitly listed, or also includes elements inherent to such process, method, article, or apparatus. Without more restrictions, elements defined by the statement “include one . . . ” do not exclude the presence of additional identical elements in the process, method, article, or apparatus that includes the elements. In addition, it should be noted that the scope of the method and apparatus in the implementations of the present disclosure is not limited to performing functions in the order shown or discussed, and may also include performing functions in a substantially simultaneous manner or in the reverse order according to the functions involved. For example, the described method may be performed in an order different from the described order, and various steps may also be added, omitted, or combined. In addition, features described with reference to certain examples may be combined in other examples.

Through the description of the above implementations, those skilled in the art can clearly understand that the above method embodiments can be implemented by means of software plus a necessary general-purpose hardware platform. Certainly, they can also be implemented by hardware, but in many cases, the former is a better implementation. Based on such understanding, the technical solution of the present disclosure, in essence or in a part that contributes to the prior art, can be embodied in the form of a computer software product, which is stored in a storage medium (such as ROM/RAM, magnetic disk, optical disk), and includes several instructions for enabling a terminal (which may be a mobile phone, a computer, a server, or a network device, etc.) to execute the methods described in various embodiments of the present disclosure.

The embodiments of the present disclosure have been described above with reference to the drawings, but the present disclosure is not limited to the above specific implementations. The above specific implementations are only illustrative, but not restrictive. Those of ordinary skill in the art can make many forms without departing from the purpose of the present disclosure and the protection scope of the claims, which all belong to the protection of the present disclosure.

1. A virtual reality safety protection method, comprising:
obtaining position information of a virtual reality display device and environment information of an environment where the virtual reality display device is located;
determining a dynamic danger range in a static environment according to the environment information; and
adjusting an interface transparent display parameter of the virtual reality display device and/or turning on a see-through mode of the virtual reality display device, according to the position information and the dynamic danger range, to remind a user wearing the virtual reality display device.

2. The virtual reality safety protection method according to claim 1, wherein the adjusting the interface transparent display parameter of the virtual reality display device according to the position information and the dynamic danger range, comprises:
adjusting a transparent parameter of at least part of an interface region of the virtual reality display device when the position information is located within the dynamic danger range.

3. The virtual reality safety protection method according to claim 1, wherein the adjusting the interface transparent display parameter of the virtual reality display device according to the position information and the dynamic danger range, comprises:
determining a display region displaying the dynamic danger range in the virtual reality display device when the position information is located within the dynamic danger range; and
controlling the display region to superimpose and display an interface of a reality environment corresponding to the dynamic danger range in a foreground.

4. The virtual reality safety protection method according to claim 1, wherein the obtaining the position information of the virtual reality display device and the environment information of the environment where the virtual reality display device is located, comprises:
determining the position information of the virtual reality display device by a plurality of degrees-of-freedom sensors on the virtual reality display device; and
determining the environment information by an external camera corresponding to the virtual reality display device.

5. The virtual reality safety protection method according to any one claim 1, further comprising:
adjusting a vibration frequency of the virtual reality display device when the position information is located within the dynamic danger range; and/or
controlling the virtual reality display device to play a reminder audio when the position information is located within the dynamic danger range; and/or
controlling at least part of an interface of the virtual reality display device to display a video image corresponding to the dynamic danger range when the position information is located within the dynamic danger range.

6-10. (canceled)

11. An electronic device, comprising:
at least a processor,
a memory, and
programs or instructions stored in the memory and executable by the processor, wherein the programs or instructions, when executed by the processor, implement a virtual reality safety protection method,
wherein the virtual reality safety protection method comprises:
obtaining position information of a virtual reality display device and environment information of an environment where the virtual reality display device is located;
determining a dynamic danger range in a static environment according to the environment information; and
adjusting an interface transparent display parameter of the virtual reality display device and/or turning on a see-through mode of the virtual reality display device, according to the position information and the dynamic danger range, to remind a user wearing the virtual reality display device.

12. A non-transitory readable storage medium, wherein the readable storage medium stores programs or instructions which, when executed by a processor, implement a virtual reality safety protection method,
wherein the virtual reality safety protection method comprises:
obtaining position information of a virtual reality display device and environment information of an environment where the virtual reality display device is located;
determining a dynamic danger range in a static environment according to the environment information; and
adjusting an interface transparent display parameter of the virtual reality display device and/or turning on a see-through mode of the virtual reality display device, according to the position information and the dynamic danger range, to remind a user wearing the virtual reality display device.

13-14. (canceled)

15. The virtual reality safety protection method according to claim 1, further comprising:
controlling the virtual reality display device to play a reminder audio when the position information is located within the dynamic danger range.

16. The virtual reality safety protection method according to claim 1, further comprising:
controlling at least part of an interface of the virtual reality display device to display a video image corresponding to the dynamic danger range when the position information is located within the dynamic danger range.

17. The virtual reality safety protection method according to claim 5, further comprising:
controlling the virtual reality display device to play a reminder audio when the position information is located within the dynamic danger range.

18. The virtual reality safety protection method according to claim 17, further comprising:
controlling at least part of an interface of the virtual reality display device to display a video image corresponding to the dynamic danger range when the position information is located within the dynamic danger range.

19. The electronic device according to claim 11, wherein the adjusting the interface transparent display parameter of the virtual reality display device according to the position information and the dynamic danger range, comprises:
adjusting a transparent parameter of at least part of an interface region of the virtual reality display device when the position information is located within the dynamic danger range.

20. The electronic device according to claim 11, wherein the adjusting the interface transparent display parameter of the virtual reality display device according to the position information and the dynamic danger range, comprises:
determining a display region displaying the dynamic danger range in the virtual reality display device when the position information is located within the dynamic danger range; and
controlling the display region to superimpose and display an interface of a reality environment corresponding to the dynamic danger range in a foreground.

21. The electronic device according to claim 11, wherein the obtaining the position information of the virtual reality display device and the environment information of the environment where the virtual reality display device is located, comprises:
determining the position information of the virtual reality display device by a plurality of degrees-of-freedom sensors on the virtual reality display device; and
determining the environment information by an external camera corresponding to the virtual reality display device.

22. The electronic device according to claim 11, wherein the virtual reality safety protection method further comprises:
adjusting a vibration frequency of the virtual reality display device when the position information is located within the dynamic danger range.

23. The electronic device according to claim 11, wherein the virtual reality safety protection method further comprises:
controlling the virtual reality display device to play a reminder audio when the position information is located within the dynamic danger range.

24. The electronic device according to claim 11, wherein the virtual reality safety protection method further comprises:
controlling at least part of an interface of the virtual reality display device to display a video image corresponding to the dynamic danger range when the position information is located within the dynamic danger range.

25. The electronic device according to claim 22, wherein the virtual reality safety protection method further comprises:
controlling the virtual reality display device to play a reminder audio when the position information is located within the dynamic danger range.

26. The electronic device according to claim 25, wherein the virtual reality safety protection method further comprises:
controlling at least part of an interface of the virtual reality display device to display a video image corresponding to the dynamic danger range when the position information is located within the dynamic danger range.

27. The non-transitory readable storage medium according to claim 12, wherein the adjusting the interface transparent display parameter of the virtual reality display device according to the position information and the dynamic danger range, comprises:
adjusting a transparent parameter of at least part of an interface region of the virtual reality display device when the position information is located within the dynamic danger range.
